(19) United States
(12) Patent Application Publication
(10) Pub. No.: US 2026/0175775 A1
(43) Pub. Date: Jun. 25, 2026

(54) PROVIDING A CONTEXTUAL ARRIVAL EXPERIENCE

(71) Applicant: HERE GLOBAL B.V., EINDHOVEN (NL)

(72) Inventors: JEROME BEAUREPAIRE, NANTES (FR); JEREMY MICHAEL YOUNG, BEVERLY HILLS, MI (US)

(73) Assignee: HERE GLOBAL B.V., EINDHOVEN (NL)

(21) Appl. No.: 18/989,438

(22) Filed: Dec. 20, 2024

(51) Int. Cl. B60Q 1/50; B60Q 5/00; G05D 1/226

(52) U.S. Cl. CPC B60Q 1/549; B60Q 1/503; B60Q 5/005; G05D 1/226; B60Q 2400/20

(57) ABSTRACT

In an example embodiment, an apparatus obtains map information corresponding to an event location. Based at least in part on the map information corresponding to the event location, the apparatus determines at least one event action to be performed by a vehicle responsive to a vehicle location indicating a location of the vehicle satisfying a proximity criteria corresponding to the event location. The apparatus causes one or more components of the vehicle to perform the at least one event action responsive to determining that the vehicle location satisfies the proximity criteria corresponding to the event location.

### TECHNOLOGICAL FIELD

Example embodiments relate generally to providing vehicle passengers with a contextual arrival experience. In particular, example embodiments generally relate to providing one or more effects corresponding to arrival of a vehicle at an event location.

### BACKGROUND

When a vehicle arrives at a location, the arrival is generally the same at each arrival location. For example, even when arriving at a special event, the vehicle's actions at the arrival are the same as at any arrival. In other words, conventionally a vehicle transporting a passenger does not make the passenger's arrival at an event seem special.

### BRIEF SUMMARY

Various embodiments provide methods, apparatus, computer program products, systems, and vehicles for providing a contextual arrival experience. In various embodiments, the contextual arrival experience may include one or more event actions that are location aware. In various embodiments, when it is determined by a vehicle apparatus onboard the vehicle or another apparatus (e.g., a user apparatus associated with a passenger of the vehicle and/or a system apparatus located remotely with respect to the vehicle) that the location of the vehicle satisfies a proximity criteria with respect to the event location, the apparatus causes one or more components of the vehicle to perform the one or more event actions. In some embodiments, the one or more event actions may include one or more audio and/or visual effects interior to the vehicle or exterior to the vehicle. In certain embodiments, the audio and/or visual effects are coordinated with the event location and/or an event occurring at the event location. In some instances, the event action provides information to the passenger(s) arriving in the vehicle regarding the arrival location and/or event occurring at the event location. In some instances, the event action is configured to make a passenger's arrival at the event feel special and/or exciting. In some instances, the event actin is configured to make other people at the event location aware of the passenger's arrival.

For example, an apparatus (e.g., a vehicle apparatus onboard the vehicle, a user apparatus associated with a passenger of the vehicle, or a system apparatus located remotely with respect to the vehicle) may obtain map information corresponding to an event location. Based on the map information, the apparatus may determine at least one event action to be performed by the vehicle as the vehicle approaches the event location and/or upon arrival at the event location. The apparatus causes one or more components of the vehicle to perform the at least one event action responsive to determining that the vehicle location satisfies a proximity criteria corresponding to the event location.

According to a first aspect, a method for causing performance of at least one event action is provided. In an example embodiment, the method includes obtaining, by at least one processor, map information corresponding to an event location; based at least in part on the map information corresponding to the event location, determining, by the at least one processor, at least one event action to be performed by a vehicle responsive to a vehicle location indicating a location of the vehicle satisfying a proximity criteria corresponding to the event location; and causing, by the at least one processor, one or more components of the vehicle to perform the at least one event action responsive to determining that the vehicle location satisfies the proximity criteria corresponding to the event location.

In an example embodiment, the map information corresponding to the event location comprises one or more of information regarding one or more road segments at least one of proximate the event location or along a route to be traveled by the vehicle enroute to the event location, one or more points of interest proximate the event location, at least a portion of the route to be traveled by the vehicle enroute to the event location, an estimated time of arrival of the vehicle at the event location, traffic information for at least one of road segments proximate the event location or along the route to be traveled by the vehicle enroute to the event location, weather information for at least one of the event location or along the route to be traveled by the vehicle enroute to the event location, a 3D model of the event location, traffic light information for one or more traffic lights along the route to be traveled by the vehicle enroute to the event location, or information regarding an event occurring at the event location.

In an example embodiment, the event location is a destination of the route being traversed by the vehicle, a location along the route being traversed by the vehicle at which the vehicle will platoon with at least one other vehicle, a location of interest along the route being traversed by the vehicle, a location along the route being traversed by the vehicle that is a destination of another vehicle.

In an example embodiment, the at least one event action is determined based at least in part on one or more of an identity of a passenger of the vehicle, a number of passengers of the vehicle, user preferences associated with at least on passenger of the vehicle, user input provided by one or more passengers of the vehicle, a physical characteristic or appearance of at least one passenger of the vehicle, sensor data generated by one or more sensors of the vehicle, or information regarding capabilities of the vehicle.

In an example embodiment, the at least one event action comprises at least one of controlling an exterior color or color pattern of the vehicle; controlling an exterior shape of the vehicle; projecting an image on a structure located at the event location; or controlling at least one of a pointing direction, color, beam shape, or beam intensity of one or more exterior lights of the vehicle. In an example embodiment, the at least one event action comprises controlling at least of a pointing direction, color, beam shape, beam intensity, projection location, or projection pattern of one or more interior lights of the vehicle. In an example embodiment, the at least one event action comprises controlling a sound scape at least one of interior to the vehicle or exterior to vehicle. In an example embodiment, the at least one event action is a coordinated action performed in coordination by two or more vehicles at the event location. In an example embodiment, the at least one event action comprises at least one of controlling operation of one or more drones in proximity to the event location, movement of the vehicle, or causing display of one or more images or textual messages on one or more public screens at the event location.

In an example embodiment, the proximity criteria corresponding to the event location is satisfied when at least one of the vehicle is expected to arrive at the event location within a set amount of time, the vehicle is within a set distance of the event location, or a door of the vehicle is opened within the set distance of the event location.

According to another aspect, an apparatus is provided. The apparatus comprises at least one processor and at least one memory storing computer program code. The at least one memory and the computer program code configured to, with the processor, cause the apparatus to at least obtain map information corresponding to an event location; based at least in part on the map information corresponding to the event location, determine at least one event action to be performed by a vehicle responsive to a vehicle location indicating a location of the vehicle satisfying a proximity criteria corresponding to the event location; and cause one or more components of the vehicle to perform the at least one event action responsive to determining that the vehicle location satisfies the proximity criteria corresponding to the event location.

In an example embodiment, the map information corresponding to the event location comprises one or more of information regarding one or more road segments at least one of proximate the event location or along a route to be traveled by the vehicle enroute to the event location, one or more points of interest proximate the event location, at least a portion of the route to be traveled by the vehicle enroute to the event location, an estimated time of arrival of the vehicle at the event location, traffic information for at least one of road segments proximate the event location or along the route to be traveled by the vehicle enroute to the event location, weather information for at least one of the event location or along the route to be traveled by the vehicle enroute to the event location, a 3D model of the event location, traffic light information for one or more traffic lights along the route to be traveled by the vehicle enroute to the event location, or information regarding an event occurring at the event location.

In an example embodiment, the event location is a destination of the route being traversed by the vehicle, a location along the route being traversed by the vehicle at which the vehicle will platoon with at least one other vehicle, a location of interest along the route being traversed by the vehicle, a location along the route being traversed by the vehicle that is a destination of another vehicle.

In an example embodiment, the at least one event action is determined based at least in part on one or more of an identity of a passenger of the vehicle, a number of passengers of the vehicle, user preferences associated with at least on passenger of the vehicle, user input provided by one or more passengers of the vehicle, a physical characteristic or appearance of at least one passenger of the vehicle, sensor data generated by one or more sensors of the vehicle, or information regarding capabilities of the vehicle.

In an example embodiment, the at least one event action comprises at least one of controlling an exterior color or color pattern of the vehicle; controlling an exterior shape of the vehicle; projecting an image on a structure located at the event location; or controlling at least one of a pointing direction, color, beam shape, or beam intensity of one or more exterior lights of the vehicle. In an example embodiment, the at least one event action comprises controlling at least of a pointing direction, color, beam shape, beam intensity, projection location, or projection pattern of one or more interior lights of the vehicle. In an example embodiment, the at least one event action comprises controlling a sound scape at least one of interior to the vehicle or exterior to vehicle. In an example embodiment, the at least one event action is a coordinated action performed in coordination by two or more vehicles at the event location. In an example embodiment, the at least one event action comprises at least one of controlling operation of one or more drones in proximity to the event location, movement of the vehicle, or causing display of one or more images or textual messages on one or more public screens at the event location.

In an example embodiment, the proximity criteria corresponding to the event location is satisfied when at least one of the vehicle is expected to arrive at the event location within a set amount of time, the vehicle is within a set distance of the event location, or a door of the vehicle is opened within the set distance of the event location.

According to another aspect, a computer program product is provided. The computer program product comprises at least one non-transitory computer-readable storage medium having computer-executable program code instructions stored therein. The computer-executable program code instructions comprising program code instructions configured to, when executed by at least one processor of an apparatus, cause the apparatus to obtain map information corresponding to an event location; based at least in part on the map information corresponding to the event location, determine at least one event action to be performed by a vehicle responsive to a vehicle location indicating a location of the vehicle satisfying a proximity criteria corresponding to the event location; and cause one or more components of the vehicle to perform the at least one event action responsive to determining that the vehicle location satisfies the proximity criteria corresponding to the event location.

In an example embodiment, the map information corresponding to the event location comprises one or more of information regarding one or more road segments at least one of proximate the event location or along a route to be traveled by the vehicle enroute to the event location, one or more points of interest proximate the event location, at least a portion of the route to be traveled by the vehicle enroute to the event location, an estimated time of arrival of the vehicle at the event location, traffic information for at least one of road segments proximate the event location or along the route to be traveled by the vehicle enroute to the event location, weather information for at least one of the event location or along the route to be traveled by the vehicle enroute to the event location, a 3D model of the event location, traffic light information for one or more traffic lights along the route to be traveled by the vehicle enroute to the event location, or information regarding an event occurring at the event location.

In an example embodiment, the event location is a destination of the route being traversed by the vehicle, a location along the route being traversed by the vehicle at which the vehicle will platoon with at least one other vehicle, a location of interest along the route being traversed by the vehicle, a location along the route being traversed by the vehicle that is a destination of another vehicle.

In an example embodiment, the at least one event action is determined based at least in part on one or more of an identity of a passenger of the vehicle, a number of passengers of the vehicle, user preferences associated with at least on passenger of the vehicle, user input provided by one or more passengers of the vehicle, a physical characteristic or appearance of at least one passenger of the vehicle, sensor data generated by one or more sensors of the vehicle, or information regarding capabilities of the vehicle.

In an example embodiment, the at least one event action comprises at least one of controlling an exterior color or color pattern of the vehicle; controlling an exterior shape of the vehicle; projecting an image on a structure located at the event location; or controlling at least one of a pointing direction, color, beam shape, or beam intensity of one or more exterior lights of the vehicle. In an example embodiment, the at least one event action comprises controlling at least of a pointing direction, color, beam shape, beam intensity, projection location, or projection pattern of one or more interior lights of the vehicle. In an example embodiment, the at least one event action comprises controlling a sound scape at least one of interior to the vehicle or exterior to vehicle. In an example embodiment, the at least one event action is a coordinated action performed in coordination by two or more vehicles at the event location. In an example embodiment, the at least one event action comprises at least one of controlling operation of one or more drones in proximity to the event location, movement of the vehicle, or causing display of one or more images or textual messages on one or more public screens at the event location.

In an example embodiment, the proximity criteria corresponding to the event location is satisfied when at least one of the vehicle is expected to arrive at the event location within a set amount of time, the vehicle is within a set distance of the event location, or a door of the vehicle is opened within the set distance of the event location.

In accordance with another aspect of the present disclosure, an apparatus is provided. In an example embodiment, the apparatus comprises means for obtaining map information corresponding to an event location. The apparatus comprises means for determining at least one event action to be performed by a vehicle responsive to a vehicle location indicating a location of the vehicle satisfying a proximity criteria corresponding to the event location, wherein the determining is performed based at least in part on the map information corresponding to the event location. The apparatus comprises means for causing one or more components of the vehicle to perform the at least one event action responsive to determining that the vehicle location satisfies the proximity criteria corresponding to the event location.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a block diagram showing an example architecture of one embodiment of the present invention;

FIG. 2A is a block diagram of a system apparatus that may be specifically configured in accordance with an example embodiment;

FIG. 2B is a block diagram of a user apparatus that may be specifically configured in accordance with an example embodiment;

FIG. 2C is a block diagram of a vehicle apparatus that may be specifically configured in accordance with an example embodiment;

FIG. 3 is a flowchart illustrating operations performed, such as by the system apparatus of FIG. 2A, the user apparatus of FIG. 2B, or the vehicle apparatus of FIG. 2C, in accordance with an example embodiment; and

FIG. 4 is a flowchart illustrating operations performed, such as by the vehicle apparatus of FIG. 2C, in accordance with an example embodiment.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

### I. General Overview

Various embodiments provide methods, apparatus, computer program products, systems, and vehicles for providing a contextual arrival experience. In various embodiments, the contextual arrival experience may include one or more event actions that are location aware. In various embodiments, when it is determined by a vehicle apparatus onboard the vehicle or another apparatus (e.g., a user apparatus associated with a passenger of the vehicle and/or a system apparatus located remotely with respect to the vehicle) that the location of the vehicle satisfies a proximity criteria with respect to the event location, the apparatus causes one or more components of the vehicle to perform the one or more event actions. In some embodiments, the one or more event actions may include one or more audio and/or visual effects interior to the vehicle or exterior to the vehicle. In certain embodiments, the audio and/or visual effects are coordinated with the event location and/or an event occurring at the event location. In some instances, the event action provides information to the passenger(s) arriving in the vehicle regarding the arrival location and/or event occurring at the event location. In some instances, the event action is configured to make a passenger's arrival at the event feel special and/or exciting. In some instances, the event action is configured to make other people at the event location aware of the passenger's arrival.

In various embodiments, an apparatus (e.g., a system apparatus remotely located from a vehicle, a vehicle apparatus onboard the vehicle, or a user apparatus associated with a passenger of the vehicle) obtains an event location. In various embodiments, the event location is a destination of a route. For example, a user may provide user input indicating a destination location to which the user would like to travel via the vehicle. In another example, a destination location is accessed from one or more applications on the user apparatus (e.g., a calendar application, an application hosting an event invitation, and/or the like). In certain embodiments, the event location is enroute to a destination location and determined based at least in part on a route to be traveled by the vehicle (e.g., to reach the destination location). For example, the vehicle may be an autonomous vehicle and the route to the destination location may include platooning with one or more other autonomous vehicles for a portion of the route. The location where the platooning vehicles assemble and/or where the vehicle joins the platoon may be the event location. The location where the vehicle departs from the platoon may be the event location. In another example, an event location may be a location of a public screen or digital display along a route the vehicle is traveling to a destination location. In some embodiments, a plurality of event locations may be identified along a route to be traveled by the vehicle. For example, the destination location may be identified as an event location and/or one or more way points along the route may be identified as event locations.

In various embodiments, the apparatus (e.g., a system apparatus remotely located from a vehicle, a vehicle apparatus onboard the vehicle, or a user apparatus associated with a passenger of the vehicle) obtains map information corresponding to the event location. In an example embodiment, the map information corresponding to the event location is provided and/or accessed via a tile or a discrete portion of a digital map or geographic database corresponding to geographic area including the event location. The geographic area may be defined socio-politically (e.g., a town, neighborhood, zip code, state, country, and/or the like) and/or may be defined as part of a grid of geographic areas. For example, a grid of a geographic area may comprise tiles that are defined based on their size (e.g., 1 km by 1 km areas, 2 km by 3 km areas, 3 km by 3 km areas, 5 km by 5 km areas, 10 km by 10 km areas, and/or the like).

In certain embodiments, the map information corresponding to the event location includes information corresponding to the road network (e.g., road segments, intersections, and/or the like) proximate the event location (e.g., located within the same tile or geographic area of the digital map or geographic database as the event location, located within a set distance of the event location, included in a route the vehicle is to travel along enroute to the event location, and/or the like). In some embodiments, the map information corresponding to the event location includes information regarding a route the vehicle is travel to reach the event location, an estimated time of arrival at the event location, traffic information for at least one road segment proximate the event location or along the route to be traveled by the vehicle enroute to the event location, and/or weather information for at least one of the event location or along the route to be traveled by the vehicle enroute to the event location. In certain embodiments, the map information corresponding to the event location includes a two-dimensional or three-dimensional model of the event location. For example, the two-dimensional or three-dimensional model of the event location may provide information regarding one or more structures (e.g., buildings, walls, bridges, overpasses, sidewalk surface, road surface, and/or other structures) located at or proximate the event location. In certain embodiments, the map information corresponding to the event location includes information regarding points of interest (POIs), such as restaurants, shops, venues, parks, libraries, services stations, refueling stations, malls, schools, and/or the like, located proximate the event location and/or along a route to be traveled by the vehicle enroute to the event location. In some embodiments, the map information corresponding to the event location includes information regarding traffic light information for one or more traffic lights along the route to be traveled by the vehicle enroute to the event location. In some embodiments, the map information corresponding to the event location includes information regarding an event occurring at the event location at a time that includes an expected arrival time of the vehicle at the event location. In some embodiments, the map information corresponding to the event location includes information regarding one or more public screens located at the event location and/or along the route to be traveled by the vehicle enroute to the event location.

In various embodiments, the apparatus (e.g., a system apparatus remotely located from a vehicle, a vehicle apparatus onboard the vehicle, or a user apparatus associated with a passenger of the vehicle) determines at least one event action to be performed by the vehicle upon arrival at the event location. For example, the apparatus may determine at least one event action to be performed when a vehicle location, which indicates a location of the vehicle, satisfies a proximity criteria corresponding to the event location. In various embodiments, the proximity criteria corresponding to the event location is satisfied when, based at least in part on the vehicle location, the vehicle is expected to arrive at the event location within a set amount of time, the vehicle location is within a set distance of the event location, or a door of the vehicle is opened when the vehicle location is within the set distance of the event location.

In various embodiments, the at least one event action is determined based at least in part on the map information corresponding to the event location. For example, the apparatus may identify a structure located at the event location on which to project an image based at least in part on the map information corresponding to the event location. In various embodiments, the at least one event action is determined based at least in part on one or more of an identity of a passenger of the vehicle, a number of passengers of the vehicle, user preferences associated with at least one passenger of the vehicle, user input provided by one or more passengers of the vehicle, a physical characteristic or appearance of at least one passenger of the vehicle, sensor data generated by one or more sensors of the vehicle, or information regarding capabilities of the vehicle.

In various embodiments, the at least one event action includes controlling an exterior color or color pattern of the vehicle, controlling an exterior shape of the vehicle, projecting an image on a structure located at the event location, and/or controlling at least one of a pointing direction, color, beam shape, or beam intensity of one or more exterior lights of the vehicle. In some embodiments, the at least one event action includes at least of a pointing direction, color, beam shape, beam intensity, projection location, or projection pattern of one or more interior lights of the vehicle. In certain embodiments, the at least one event action includes controlling a sound scape at least one of interior to the vehicle or exterior to vehicle. In some embodiments, the at least one event action is a coordinated action performed in coordination by two or more vehicles at the event location. In various embodiments, the at least one event action includes controlling operation of one or more drones in proximity to the event location (e.g., to provide a light display, to provide a soundscape, to project one or more images on one or more structures, and/or the like), movement of the vehicle, or causing display of one or more images or textual messages on one or more public screens at the event location or along the route traveled by the vehicle to the event location.

In various embodiments, the apparatus (e.g., a system apparatus remotely located from a vehicle, a vehicle apparatus onboard the vehicle, or a user apparatus associated with a passenger of the vehicle) causes one or more components to perform the at least one event action responsive to determining that the vehicle location satisfies the proximity criteria corresponding to the event location. When the apparatus is the system apparatus or a user apparatus associated with a passenger of the vehicle, the apparatus causes the one or more components to perform the at least one event action by providing a message or communication configured for receipt by the vehicle apparatus that includes instructions configured to cause the vehicle apparatus to control operation of one or more components of the vehicle to cause the at least one event action to be performed responsive to determining that the vehicle location satisfies the proximity criteria corresponding to the event location. In some embodiments, the message or communication includes executable instructions that when executed by the vehicle apparatus, causes the vehicle apparatus to control operation of one or more components of the vehicle such that the at least one event action is performed responsive to determining that the vehicle location satisfies the proximity criteria corresponding to the event location. In some embodiments, the message or communication references executable instructions that are stored in a memory of the vehicle apparatus that when accessed and executed by the vehicle apparatus causes the vehicle apparatus to control operation of one or more components of the vehicle such that the at least one event action is performed responsive to determining that the vehicle location satisfies the proximity criteria corresponding to the event location.

In some embodiments, the apparatus is the vehicle apparatus. In such embodiments, the apparatus causes the one or more components to perform the at least one event action by controlling the operation of the one or more components of the vehicle such that the at least one event action is performed responsive to determining that the vehicle location satisfies the proximity criteria corresponding to the event location.

Conventionally, when a vehicle arrives at a location the arrival is generally the same at each arrival location. In other words, conventionally, nothing regarding a vehicle's arrival at a location is tailored to the context of the location or an event occurring at the location. For example, the vehicle's arrival at the location may not provide any direction to which way a passenger should walk when they exit the vehicle or may not provide any fanfare regarding the arrival of the passenger at the location. In another example, on-lookers and other drivers may not be able to identify a group of vehicles that are platooning and therefore may attempt to merge into the group of platooning vehicles. Therefore, technical challenges exist regarding providing a contextual experience regarding the arrival of a vehicle at a location.

Various embodiments provide technical solutions to these technical challenges. For example, various embodiments provide a contextual arrival experience for a passenger of a vehicle when the vehicle arrives at an event location. The contextual arrival experience includes at least one event action performed upon arrival of the vehicle at the event location. The event action may provide information to the passenger regarding arrival at the event location (e.g., the direction the passenger should walk upon exiting the vehicle), provide fanfare regarding the passenger's arrival at the event location, provide a cohesive view of a group of platooning vehicles, and/or the like. For example, the performance of the event action improves the user experience of a passenger of the vehicle by tailoring the arrival of the vehicle at the event location based on the event location and/or an event occurring at the event location at the time the vehicle arrives at the event location. Therefore, various embodiments provide technical improvements to various technical fields such as vehicle system operations, user experience of a vehicle, and/or the like.

### II. Example Architecture

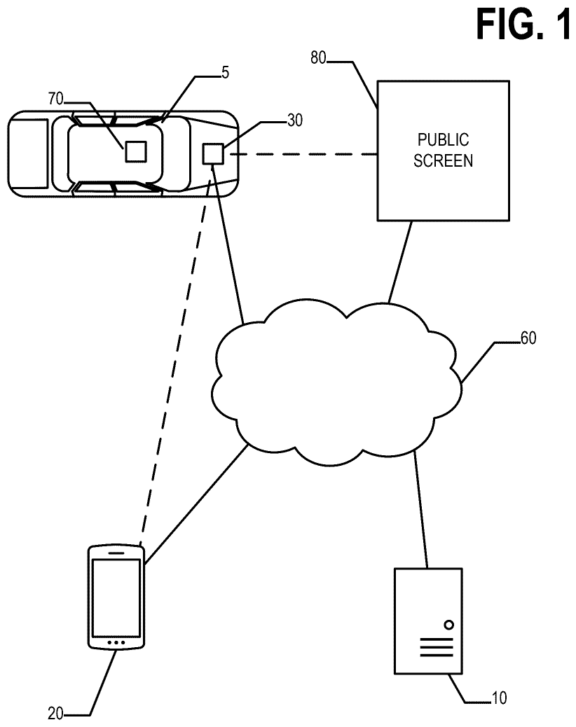

FIG. 1 provides an illustration of an example system that can be used in conjunction with various embodiments of the present invention. As shown in FIG. 1, the system may include one or more system apparatuses 10, one or more user apparatuses 20, one or more vehicle apparatuses 30, one or more public screens 80, one or more networks 60, and/or the like. In various embodiments, the vehicle apparatus 30 may be an in-vehicle navigation system, vehicle control system, a mobile computing device, and/or the like. For example, a vehicle apparatus 30 may be an in-vehicle navigation system mounted within and/or be on-board a vehicle 5 such as a motor vehicle, non-motor vehicle, automobile, car, scooter, truck, van, bus, motorcycle, bicycle, Segway, golf cart, and/or the like. In various embodiments, the user apparatus 20 may be a smartphone, tablet, personal digital assistant (PDA), and/or other mobile computing device associated with a passenger of a vehicle 5. In an example embodiment, a system apparatus 10 is a computer, server, Cloud computing resource, and/or the like. In certain embodiments, the vehicle apparatus 30 is a vehicle control system configured to autonomously drive a vehicle, assist in control of a vehicle, and/or the like.

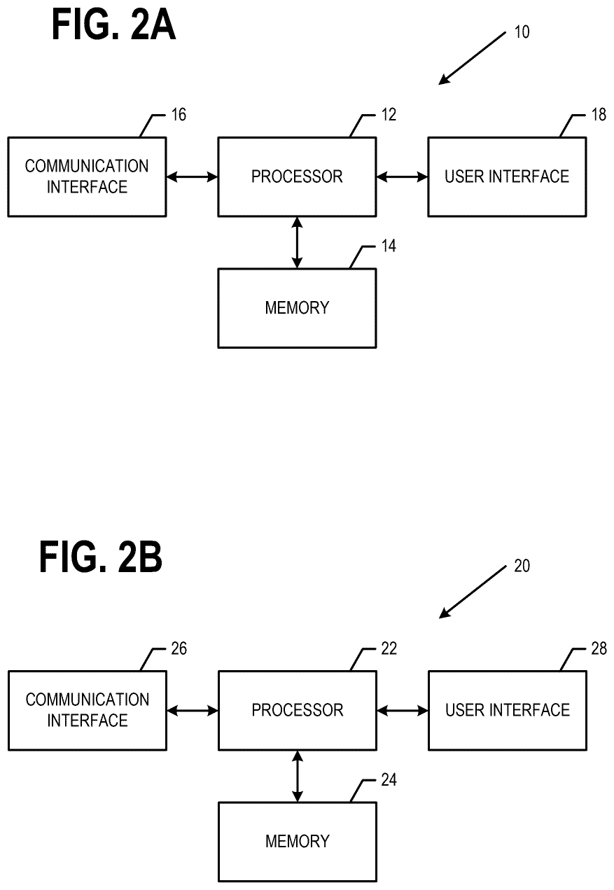

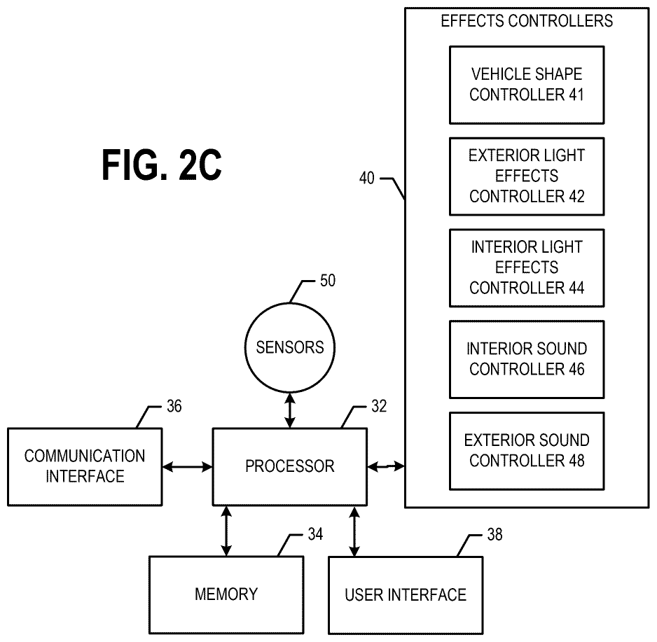

In example embodiments, a system apparatus 10 may comprise components similar to those shown in the example system apparatus 10 diagrammed in FIG. 2A. In various embodiments, a user apparatus 20 may comprise components similar to those shown in the example user apparatus 20 diagrammed in FIG. 2B. In some embodiments, a vehicle apparatus 30 comprises components similar to those shown in FIG. 2C.

In various embodiments, the system apparatus 10 may be located remotely from the vehicle apparatus 30. The user apparatus 20 may be located remotely from the vehicle 5 or may be carried onboard the vehicle 5 by a passenger with which the user apparatus 20 is associated. Each of the components of the system may be in electronic communication with, for example, one another over the same or different wireless or wired networks 60 including, for example, a wired or wireless Personal Area Network (PAN), Local Area Network (LAN), Metropolitan Area Network (MAN), Wide Area Network (WAN), cellular network, and/or the like. In some embodiments, a network 60 may comprise the automotive cloud, digital transportation infrastructure (DTI), radio data system (RDS)/high-definition radio (HD) or other digital radio system, and/or the like. For example, a vehicle apparatus 30 may be in communication with a system apparatus 10 via the network 60. For example, the vehicle apparatus 30 may communicate with the system apparatus 10 via the Cloud. In various embodiments, the vehicle apparatus 30 may communicate with a user apparatus 20 via the network 60 and/or via a direct wired or wireless communications (e.g., short range radio communications such as Bluetooth, Bluetooth Low Energy, near field communication (NFC), and/or the like).

As shown in FIG. 2A, the system apparatus 10 of an example embodiment may include, may be associated with or may otherwise be in communication with a processor 12 and a memory device 14 and optionally a communication interface 16 and/or a user interface 18. As shown in FIG. 2B, a user apparatus 20 of an example embodiment may include, may be associated with, or may otherwise be in communication with a processor 22, and a memory device 24, and optionally a communication interface 26, a user interface 28, and/or optionally one or more sensors (e.g., a location sensor such as a GPS sensor; camera(s); accelerometer(s), gyroscope(s), and/or other sensors).

As shown in FIG. 2C, a vehicle apparatus 30 of an example embodiment may include, may be associated with, or may otherwise be in communication with a processor 32, and a memory device 34, and optionally a communication interface 36, a user interface 38, and/or one or more sensors 50 (e.g., a location sensor such as a GPS sensor; camera(s); 2D and/or 3D LiDAR(s); long, medium, and/or short range RADAR; ultrasonic sensors; electromagnetic sensors; (near-)IR cameras, 3D cameras, 360° cameras, accelerometer(s), gyroscope(s), and/or other sensors that enable the vehicle apparatus to determine one or more features of the corresponding vehicle's surroundings), and one or more effects controllers 40 configured to control respective components of the vehicle to cause the respective components to perform one or more event actions. For example, the effects controllers 40 may include a vehicle shape controller 41 configured to control positioning of one or more adaptable elements of the vehicle. For example, the one or more adaptable elements may be movable between particular positions such that the shape of the vehicle may be controlled. In certain embodiments, the effects controllers 40 include an exterior light effects controller 42 configured to control operation of one or more exterior lights and/or displays of the vehicle to control one or more images displayed on one or more exterior displays of the vehicle, an exterior color or color pattern of the vehicle, project an image on a structure located at the event location, control at least one of a pointing direction, color, beam shape, or beam intensity of one or more exterior lights of the vehicle, and/or the like. In some embodiments, the effects controllers 40 include an interior light effects controller 44 configured to control operation of one or more interior lights and/or displays of the vehicle to control at least of a pointing direction, color, beam shape, beam intensity, projection location, or projection pattern of one or more interior lights of the vehicle and/or at least one image displayed by an interior display of the vehicle. In various embodiments, the effects controllers 40 include an interior sound controller 46 configured to control, at least in part, an interior sound scape of the vehicle (e.g., via controlling operation of one or more interior speakers of the vehicle). In various embodiments, the effects controllers 40 include an exterior sound controller 48 configured to control, at least in part, an exterior sound scape of the vehicle (e.g., via controlling operation of one or more exterior speakers of the vehicle). In various embodiments, the effects controllers 40 may include additional and/or different effects controllers configured to control various components of the vehicle to cause performance of at least one event action.

Example embodiments of the system apparatus 10, user apparatus 20, and vehicle apparatus 30 are described in more detail below with respect to FIGS. 2A, 2B, and 2C.

In some embodiments, a system apparatus 10, user apparatus 20, and/or vehicle apparatus 30 may communicate with a public screen 80 and/or digital display along a route being traversed by the vehicle 5 via network 60. In some embodiments, a user apparatus 20 carried on the vehicle 5 by a passenger and/or the vehicle apparatus 30 may communicate with a public screen 80 and/or digital display via direct wireless communication. For example, the public screen 80 and/or digital display may be a dynamic LED road or highway sign, a billboard or other display configured to present advertisements. For example, the location of the public screen 80 and/or digital display may be an event location and an event action may be displaying an image or message via the public screen 80 and/or digital display as the vehicle passes the public screen 80 and/or digital display as the vehicle traverses the route to the destination location.

In various embodiments, a public screen 80 and/or digital display may include components similar to a system apparatus 10 and/or a user apparatus 20. For example, a public screen 80 and/or digital display may include a processor, memory, communication interface, and a user interface (e.g., including the screen or display and possibly one or more user input devices and/or additional output devices).

### III. Example Method of Providing a Contextual Arrival Experience

In various embodiments a vehicle apparatus 30 is configured to provide one or more passengers of a vehicle 5 with a contextual arrival experience. For example, when the vehicle 5 approaches or reaches an event location (which may be a destination location of a route or a location along the route to the destination location), the vehicle apparatus 30 controls operation of one or more components of the vehicle 5 to cause the vehicle 5 to perform at least one event action.

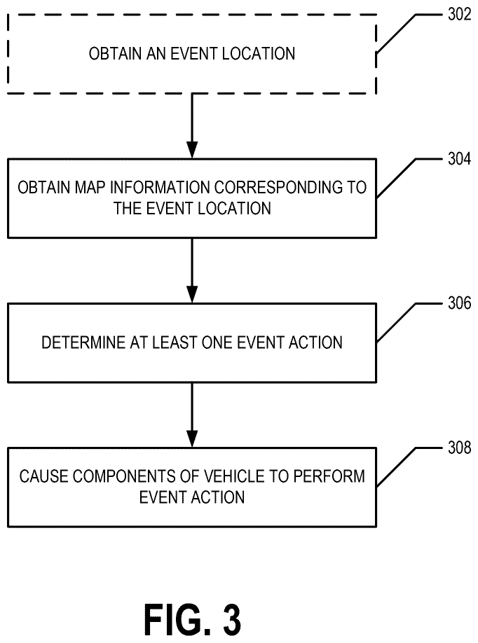

FIG. 3 provides a flowchart of operations performed by a system apparatus 10, user apparatus 20, and/or a vehicle apparatus 30 to cause at least one event action to be performed when a vehicle location, which indicates the location of the vehicle 5, satisfies one or more proximity criteria corresponding to the event location. Starting at step 302, the system apparatus 10, user apparatus 20, and/or vehicle apparatus 30 obtains an event location. For example, the system apparatus 10, user apparatus, and/or vehicle apparatus 30 comprises means, such as processor 12, 22, 32, memory 14, 24, 34, communication interface 16, 26, 36, user interface 18, 28, 38, and/or the like for obtaining an event location.

For example, a user may interact with a user interface 28, 38 of a user apparatus 20 and/or a vehicle apparatus 30 to provide a destination location to which the user would like to travel via the vehicle 5. In certain embodiments, the user may provide input indicating that they are traveling to the destination location as part of an event and/or that they would like at least one event action to be performed as part of their arrival at the destination location. In another example, a destination location may be access from an application operating on the user apparatus 20 (e.g., a calendar application; an invitation received via text message, email, or other application; and/or the like). In certain embodiments, the application may include an indication that the destination location is associated with an event.

In various embodiments, the event may be a party, wedding, festival, award ceremony, evening out with friends, a dining out experience, and/or other occasion where a passenger may want to experience a contextual arrival. In certain embodiments, the user may provide input (e.g., via user interface 28, 38) indicating that the user wants the destination location to be considered an event. In some embodiments, a user profile corresponding to the passenger associated with the user apparatus 20 is stored by the system apparatus 10, user apparatus 20, and/or vehicle apparatus 30. The user profile may provide information and/or user preferences regarding which types of destination locations the passenger would like to be considered event and/or for which types of destination locations the passenger would like to experience a contextual arrival.

The user apparatus 20 and/or vehicle apparatus 30 may provide (e.g., transmit) the destination location and an indication that the destination location should be considered an event and/or that the passenger would like to experience a contextual arrival at the destination location via communication interface 26, 36. A system apparatus 10 may receive the destination location and the indication that the destination location should be considered an event and/or that the passenger would like to experience a contextual arrival at the destination location that was provided by the user apparatus 20 and/or vehicle apparatus 30 via communication interface 16. In certain embodiments, a user apparatus 20 may receive the destination location and the indication that the destination location should be considered an event and/or that the passenger would like to experience a contextual arrival at the destination location that was provided by the vehicle apparatus 30 via communication interface 26. In certain embodiments, a vehicle apparatus 30 may receive the destination location and the indication that the destination location should be considered an event and/or that the passenger would like to experience a contextual arrival at the destination location that was provided by the user apparatus 20 via communication interface 36.

In various embodiments, a route from a starting location (e.g., a current location of the user apparatus 20 and/or vehicle apparatus 30 and/or another starting location) to the destination location is determined and/or received. For example, the system apparatus 10, user apparatus 20, and/or vehicle apparatus 30 may execute a route determination algorithm, module, program, and/or the like to determine a route from the starting location to the destination location based on map information of a digital map and/or geographic database. In another example, the system apparatus 10, user apparatus 20, and/or vehicle apparatus 30 may receive (e.g., via communication interface 16, 26, 36) a route from the starting location to the destination location determined by another computing entity (e.g., Cloud computing resource and/or the like).

In various embodiments, the system apparatus 10, user apparatus 20, and/or vehicle apparatus 30 determines that the destination location is an event location based on the indication that the destination location should be considered an event and/or that the passenger would like to experience a contextual arrival at the destination location. In an example embodiment, one or more event locations are identified along the route from the starting location to the destination location. For example, a location of a public screen 80 along the route from the starting location to the destination location may be identified as an event location. In another example, a location along the route from the starting location to the destination location at which the vehicle 5 is to join a group of platooning vehicles may be identified as an event location. In another example, a location along the route from the starting location to the destination location at which the vehicle 5 is to depart or leave a group of platooning vehicles may be identified as an event location. For example, in various embodiments, the system apparatus 10, user apparatus 20, and/or vehicle apparatus 30 obtains one or more event locations corresponding to a user traveling as a passenger of a vehicle 5 from a staring location to a destination location by receiving or accessing the destination location and, based at least in part on the route and/or user preferences stored in a user profile corresponding to the user, determining and/or identifying the one or more event locations.

At step 304, the system apparatus 10, user apparatus 20, and/or vehicle apparatus 30 obtains map information corresponding to the event location. For example, the system apparatus 10, user apparatus 20, and/or vehicle apparatus 30 comprises means, such as processor 12, 22, 32, memory 14, 24, 34, communication interface 16, 26, 36, and/or the like, configured for obtaining map information corresponding to the event location. In various embodiments, the system apparatus 10, user apparatus 20, and/or vehicle apparatus 30 obtains the map information corresponding to the event location by accessing and/or receiving the map information corresponding to the event location from a digital map and/or geographic database. For example, the system apparatus 10, user apparatus 20, and/or vehicle apparatus 30 may store in memory 14, 24, 34, at least a portion (e.g., at least one tile) of a digital map or geographic database corresponding to a geographic area in which the event location is located. In another example, the system apparatus 10, user apparatus 20, and/or vehicle apparatus 30 may request and receive, via communication interface 16, 26, 36, at least a portion (e.g., at least one tile) of a digital map or geographic database corresponding to a geographic area in which the event location is located.

In certain embodiments, the map information corresponding to the event location includes information corresponding to the road network (e.g., road segments, intersections, and/or the like) proximate the event location (e.g., located within the same tile or geographic area of the digital map or geographic database as the event location, located within a set distance of the event location, included in a route the vehicle is to travel along enroute to the event location, and/or the like). In some embodiments, the map information corresponding to the event location includes information regarding the route the vehicle is travel to reach the event location, an estimated time of arrival at the event location, traffic information for at least one road segment proximate the event location or along the route to be traveled by the vehicle enroute to the event location, and/or weather information for at least one of the event location or along the route to be traveled by the vehicle enroute to the event location. In certain embodiments, the map information corresponding to the event location includes a two-dimensional or three-dimensional model of the event location. For example, the two-dimensional or three-dimensional model of the event location may provide information regarding one or more structures (e.g., buildings, walls, bridges, overpasses, sidewalk surface, road surface, and/or other structures) located at or proximate the event location. In certain embodiments, the map information corresponding to the event location includes information regarding points of interest (POIs), such as restaurants, shops, venues, parks, libraries, services stations, refueling stations, malls, schools, and/or the like, located proximate the event location and/or along a route to be traveled by the vehicle enroute to the event location. In some embodiments, the map information corresponding to the event location includes information regarding traffic light information for one or more traffic lights along the route to be traveled by the vehicle enroute to the event location. In some embodiments, the map information corresponding to the event location includes information regarding an event occurring at the event location at a time that includes an expected arrival time of the vehicle at the event location. In some embodiments, the map information corresponding to the event location includes information regarding one or more public screens located at the event location and/or along the route to be traveled by the vehicle enroute to the event location. In an example embodiment, the map information corresponding to the event location may include information specific to a period of time during which the passenger is expected to arrive at the event location. For example, the event location may be a festival and the map information corresponding to the event location may include at least a portion of the festival schedule.

At step 306, the system apparatus 10, user apparatus 20, and/or vehicle apparatus 30 determines at least one event action to be performed when the vehicle location, which indicates the location of the vehicle 5, satisfies proximity criteria corresponding to the event location. For example, the system apparatus 10, user apparatus 20, and/or vehicle apparatus 30 comprises means, such as processor 12, 22, 32, memory 14, 24, 34, and/or the like, for determining at least one event action to be performed when the vehicle location satisfies the proximity criteria corresponding to the event location.

In some embodiments, the at least one event action is determined based at least in part on one or more of an identity of a passenger of the vehicle (e.g., user preferences stored in a user profile corresponding to the passenger), a number of passengers of the vehicle, user preferences associated with at least one passenger of the vehicle, user input provided by one or more passengers of the vehicle, a physical characteristic or appearance of at least one passenger of the vehicle, and/or sensor data generated by one or more sensors of the vehicle. For example, when one or more passengers get into vehicle 5, sensors 50 (e.g., cameras) may take pictures of the passengers. The pictures may be processed to determine colors worn by the one or more passengers and the at least one event action may include causing a color of the vehicle 5 to match or accent one or more colors worn by the passenger(s), for example. In another example sensors 50 in the vehicle 5 may determine which seats within the vehicle 5 are occupied and use that information to determine which door(s) will be opened for the passenger(s) to exit the vehicle and may determine the at least one event action based thereon. For example, an image may be projected onto a structure (e.g., road surface or sidewalk surface) adjacent, near, or generally under each door that is expected to be opened for the passenger(s) to exit the vehicle 5. In another example, a passenger may interact with a user interface 38 within the vehicle 5 and provide input indicating and/or selecting one or more event actions the passenger would like to have performed upon arrival at the event location.

In some embodiments, the at least one event action is determined based at least in part on information regarding capabilities of the vehicle. For example, the information regarding capabilities of the vehicle 5 may indicate whether the vehicle 5 is equipped with and/or comprises one or more LED lights (e.g., in addition to the headlights and/or taillights) or one or more LED displays 70 on one or more exterior surfaces of the vehicle 5, projectors, and/or the like. In another example, the information regarding capabilities of the vehicle 5 may indicate whether the vehicle 5 is equipped with and/or comprises one or more exterior speakers. In another example, the information regarding capabilities of the vehicle 5 may indicate whether the vehicle 5 is configured to host one or more drones that may be launched to provide a light display, affect an exterior soundscape, to project one or more images, and/or the like. In another example, the information regarding capabilities of the vehicle 5 may indicate whether the vehicle 5 is equipped with and/or comprises interior lights, interior displays, interior speakers, and/or the like. For example, the at least one event action may be selected or determined such that the vehicle 5, according to the information regarding capabilities of the vehicle 5, is able to perform the at least one event action.

In an example embodiment, the at least one event action includes controlling an exterior color or color pattern of the vehicle 5. For example, the vehicle 5 may include one or more exterior LED lights and/or displays 70 and the exterior light effects controller 42 may be configured to control operation of the one or more exterior LED lights or displays 70 to cause an exterior color or color pattern of the vehicle 5 to be a selected color, color pattern, or animated color pattern. For example, the event action may include controlling operation of one or more LED lights and/or displays 70 on one or more exterior surfaces of the vehicle 5 to control an appearance of the vehicle.

In an example embodiment, the at least one event action includes projecting an image on a structure located at the event location. In various embodiments, the structure is a building, wall, bridge, overpass, sidewalk surface, road surface, and/or other physical structure present at the event location. For example, the vehicle 5 may be equipped with one or more projectors configured to project images on surfaces exterior to the vehicle such that the vehicle 5 is able to project an image onto a structure located at the event location. For example, the exterior light effects controller 42 may be configured to control operation of one or more projectors to cause the one or more projectors to display respective images onto one or more structures located at the event location. The image may correspond to the vehicle 5 (e.g., a make or model of the vehicle), the event (e.g., the event may be a basketball game and the projected image is a basketball, a logo of a team playing in the basketball game, and/or the like), the passenger or preferences of the passenger (e.g., an image of the passenger's favorite player that is playing in the basketball game, the logo for the passenger's favorite basketball team, an image representing an interest of the passenger, and/or the like), or the event location (e.g., the image may indicate a direction to be walked by the passenger(s) upon exiting the vehicle 5, highlighting an architectural feature of the event location, and/or the like).

In an example embodiment, the at least one event action includes controlling at least one of a pointing direction, color, beam shape, or beam intensity of one or more exterior lights of the vehicle. In certain embodiments, the exterior light effects controller 42 may be configured to control at least one of a pointing direction, color, beam shape, or beam intensity of one or more exterior lights (e.g., headlights, taillights, and/or the like) of the vehicle. For example, the headlights of the vehicle 5 may be changed to a favorite color of a passenger or to a color that corresponds to the event (e.g., red for a red-carpet event, red and green for a Christmas festival, and/or the like) and/or pointed along a path to be walked by the passenger(s) upon exiting the vehicle 5 or pointed to emphasize an architectural feature of the event location.

In an example embodiment, the at least one event action includes controlling an exterior shape of the vehicle. For example, the vehicle 5 may include the one or more adaptable elements may be movable between particular positions such that the shape of the vehicle may be controlled. A vehicle shape controller 41 of the vehicle apparatus 30 is configured to control the positioning of one or more adaptable elements of the vehicle. For example, performing the at least one event action may include controlling the positioning of the one or more adaptable elements via the vehicle shape controller 41 to cause the vehicle 5 to have a selected exterior shape.

In an example embodiment, the at least one event action includes controlling at least one of a pointing direction, color, beam shape, beam intensity, projection location, or projection pattern of one or more interior lights of the vehicle 5. In certain embodiments, the interior light effects controller 44 may be configured to control controlling at least one of a pointing direction, color, beam shape, beam intensity, projection location, or projection pattern of one or more interior lights of the vehicle 5.

In some embodiments, the at least one event action includes controlling a sound scape interior to the vehicle. For example, an interior sound controller 46 of the vehicle apparatus 30 may be configured to control one or more interior speakers of the vehicle 5 such that the soundscape (e.g., volume of sound, placement of sound within the vehicle 5, what is being played by the speakers, etc.) may be controlled. For example, a song or sound clip or a particular portion of a song or sound clip selected by a passenger or by the system apparatus 10, user apparatus 20, or vehicle apparatus 30 may be played within the vehicle 5 as the vehicle 5 approaches the event location (e.g., when the vehicle location satisfies the proximity criteria corresponding to the event location).

In some embodiments, the at least one event action includes controlling a sound scape exterior to the vehicle. For example, an exterior sound controller 48 of the vehicle apparatus 30 may be configured to control one or more exterior speakers of the vehicle 5 such that the soundscape (e.g., volume of sound, placement/projection of sound around the vehicle 5, what is being played by the speakers, etc.) may be controlled. For example, a song or sound clip or a particular portion of a song or sound clip selected by a passenger or by the system apparatus 10, user apparatus 20, or vehicle apparatus 30 may be played outside the vehicle 5 as the vehicle 5 approaches the event location, as the passengers exit the vehicle, and/or the like (e.g., when the vehicle location satisfies the proximity criteria corresponding to the event location).

In some embodiments, the at least one event action is a coordinated action performed in coordination by two or more vehicles at the event location. For example, the event location may be a location where the vehicle 5 joins up with and/or merges into a group or arrangement of vehicles that are platooning with one another. The at least one event action may include coordinating an exterior appearance (e.g., shape via the vehicle shape controller 41, exterior color, color pattern, or animated color pattern via the exterior light effects controller 42, and/or the like) of the platooning vehicles. For example, the exterior appearance of the platooning vehicles may be coordinated such that on-lookers and/or other drivers may be aware of the coordination of platooning vehicles. In some embodiments, the movement and/or handling of the platooning vehicles may be coordinated. For example, the at least one event action may include controlling movement of the vehicle, in certain embodiments.

In an example embodiment, an event action may correspond to an event location at which the vehicle 5 is leaving or departing a group of platooning vehicles. The event action may include change the exterior appearance (e.g., shape via the vehicle shape controller 41, exterior color, color pattern, or animated color pattern via the exterior light effects controller 42, and/or the like) to differentiate the vehicle 5 from the platooning vehicles.

In some embodiments, the at least one event action includes controlling operation of one or more drones in proximity to the event location. In an example embodiment, the drones are onboard the vehicle 5 for at least a portion of the time the vehicle 5 is traveling along the route. The drones may be controlled to provide a light display, affect an exterior soundscape at the event location, to project one or more images on structures at the event location, and/or the like.

In some embodiments, the at least one event action in includes causing display of one or more images or textual messages on one or more public screens 80 or LED displays located at the event location. For example, a public screen 80 or LED display may be located at the destination location or along a route to the destination location. When the vehicle location satisfies the proximity criteria corresponding to the event location (e.g., the destination location and/or the location of the public screen 80 or LED display), the vehicle apparatus 30 may communicate with the public screen 80 or LED display (e.g., via communication interface 36) responsive to the vehicle location satisfying the proximity criteria corresponding to the event location to cause the public screen 80 or LED display to display an image or textual message for a period of time. In an example embodiment, the period of time is in a range of ten seconds to ten minutes. For example, the image or textual message may be displayed such that the passengers of the vehicle 5 are able to view the image or textual message.

In various embodiments, the proximity criteria corresponding to the event location is satisfied when, based at least in part on the vehicle location, the vehicle is expected to arrive at the event location within a set amount of time, the vehicle location is within a set distance of the event location, or a door of the vehicle is opened when the vehicle location is within the set distance of the event location. In some embodiments, the proximity criteria is a set or default proximity criteria for the vehicle 5. For example, the same proximity criteria may be applied to each even location and/or each performance of an event action. In certain embodiments, the proximity criteria is determined based at least in part on the map information corresponding to the event location (e.g., where at the event location the passenger is expected to exit the vehicle 5), user preferences stored in a user profile corresponding to the passenger, the at least one event action, and/or the like.

In some embodiments two or more event actions are identified for an event location and each of the event actions may be associated with a particular proximity criteria. For example, a first event action to be performed when the vehicle location satisfies a first proximity criteria corresponding to the event location may be controlling the interior soundscape of the vehicle 5 and a second event action to be performed when the vehicle location satisfies a second proximity criteria corresponding to the event location may be projecting an image on a structure at the event location. The first proximity criteria may be when the expected time until arrival at the event location is less than a set time. For example, when the vehicle 5 is three minutes away from arriving at the event location, the vehicle 5 may cause a particular song to be played that will reach a particular portion of the song (e.g., a crescendo, end of the song, a particular lyric, and/or the like) when the vehicle 5 arrives at the event location. The second proximity criteria may be when a door of the vehicle 5 is opened when the vehicle 5 is located within fifty meters of the event location. For example, when a door of the vehicle 5 is opened within fifty meters of the event location, one or more exterior (LED) lights and/or displays 70 of the vehicle 5 project an image on a structure at the event location.

At step 308, the system apparatus 10, user apparatus 20, and/or vehicle apparatus 30 causes components of the vehicle 5 to perform the at least one event action responsive to the vehicle location satisfying the proximity criteria corresponding to the event location. For example, the system apparatus 10, user apparatus 20, and/or vehicle apparatus 30 comprise means, such as processor, 12, 22, 32, memory 14, 24, 34, communication interface 16, 26, 36, and/or the like, for causing one or more components of the vehicle 5 to perform the at least one event action responsive to the vehicle location satisfying the proximity criteria corresponding to the event location.

In some embodiments, the system apparatus 10 and/or user apparatus 20 determined the at least one event action to be performed by the vehicle 5 responsive to the vehicle location satisfying the proximity criteria corresponding to the event location. In such embodiments, the system apparatus 10 and/or the user apparatus 20 generates a message or communication configured for receipt by the vehicle apparatus 30 and that includes instructions configured to cause the vehicle apparatus 30 to control operation of one or more components of the vehicle 5 to cause the at least one event action to be performed responsive to determining that the vehicle location satisfies the proximity criteria corresponding to the event location. In some embodiments, the message or communication includes executable instructions that, when executed by the vehicle apparatus 30, causes the vehicle apparatus 30 to control operation of one or more components of the vehicle 5 such that the at least one event action is performed responsive to determining that the vehicle location satisfies the proximity criteria corresponding to the event location. In some embodiments, the message or communication references executable instructions that are stored in a memory 34 of the vehicle apparatus 30 that when accessed and executed by the vehicle apparatus 30 causes the vehicle apparatus 30 to control operation of one or more components of the vehicle such that the at least one event action is performed responsive to determining that the vehicle location satisfies the proximity criteria corresponding to the event location. The system apparatus 10 and/or the user apparatus 20 may provide (e.g., transmit) the message or communication and the vehicle apparatus 30 may receive the message or communication. Responsive to receiving and/or processing the message or communication, the vehicle apparatus 30 executes executable instructions included in and/or referenced by the message or communication to cause the one or more components of the vehicle 5 to perform the at least one event action responsive to determining that the vehicle location satisfies the proximity criteria corresponding to the event location.

In some embodiments, the vehicle apparatus 30 determines the at least one event action to be performed by the vehicle 5. In such embodiments, the vehicle apparatus 30 causes the one or more components to perform the at least one event action by controlling the operation of the one or more components of the vehicle 5 such that the at least one event action is performed responsive to determining that the vehicle location satisfies the proximity criteria corresponding to the event location. For example, the vehicle apparatus 30 may access executable instructions (e.g., stored in memory 34) that when executed by the processor 32 cause the vehicle apparatus 30 to control operation of one or more components of the vehicle 5 such that the one or more components of the vehicle 5 perform the at least one event action responsive to a determination that the vehicle location satisfies the proximity criteria corresponding to the event location.

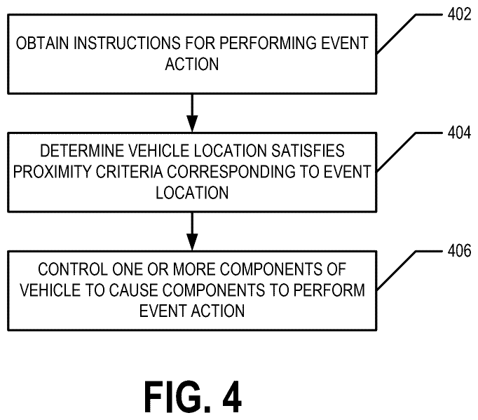

FIG. 4 provides a flowchart illustrating various processes, procedures, operations, and/or the like performed by a vehicle apparatus 30 to control operation of one or more components of a vehicle 5 to cause the one or more components to perform the at least one event action.

Starting at step 402, the vehicle apparatus 30 obtains instructions for performing the at least one event action. For example, the vehicle apparatus 30 comprises means, such as processor 32, memory 34, communication interface 36, and/or the like, for obtaining instructions for performing the at least one event action. In some embodiments, the vehicle apparatus 30 obtains the instructions for performing the at least one event action by receiving (e.g., via communication interface 36) a message or communication generated and/or provided by a system apparatus 10 and/or user apparatus 20 that includes executable instructions or that references executable instructions (stored in memory 34) configured for causing the vehicle 5 to perform the at least one event action. In certain embodiments, the vehicle apparatus 30 obtains the instructions for performing the at least one event action by generating and/or accessing the instructions from memory 34. For example, responsive to determining at least one event action to be performed responsive to determining that the vehicle location satisfies the proximity criteria corresponding to the event location, the vehicle apparatus 30 may access executable instructions stored in memory 34 that are configured for causing the vehicle 5 to perform the at least one event action.

At step 404, the vehicle apparatus 30 determines that the vehicle location satisfies the proximity criteria corresponding to the event location. For example, the vehicle apparatus 30 comprises means, such as processor 32, memory 34, sensors 50, and/or the like, for determining that the vehicle location satisfies the proximity criteria corresponding to the event location. For example, the vehicle apparatus 30 may monitor the vehicle location (e.g., via sensors 50). The vehicle apparatus 30 may then compare the vehicle location to the proximity criteria to determine whether the proximity criteria is satisfied. In some embodiments, the determination of whether the proximity criteria is satisfied is determined based at least in part on sensor data generated by one or more sensors 50 of the vehicle 5. For example, sensor data generated by a door sensor configured to indicate whether a door of the vehicle 5 is open or closed, may be used to determine whether the vehicle location satisfies the proximity criteria corresponding to the event location, in an example embodiment.

At step 406, the vehicle apparatus 30 controls operation of one or more components of the vehicle 5 to cause the vehicle 5 to perform the at least one event action. For example, the vehicle apparatus 30 comprises means, such as processor 32, memory 34, effects controllers 40, and/or the like, for controlling operation of one or more components of the vehicle 5 to cause the vehicle 5 to perform the at least one event action.

For example, in an example embodiment, the exterior light effects controller 42 controls operation of the one or more exterior LED lights or displays 70 of the vehicle 5 to cause an exterior color or color pattern of the vehicle 5 to be a selected color, static color pattern, or animated color pattern. For example, performing the at least one event action may include controlling operation of one or more LED lights and/or displays 70 on one or more exterior surfaces of the vehicle 5 to control an appearance of the vehicle.

In an example embodiment, the exterior light effects controller 42 controls operation of one or more projectors of the vehicle 5 to cause the one or more projectors to display respective images onto one or more structures located at the event location. In various embodiments, the structure is a building, wall, bridge, overpass, sidewalk surface, road surface, and/or other physical structure present at the event location. For example, the vehicle 5 may be equipped with one or more projectors configured to project images on surfaces exterior to the vehicle such that the vehicle 5 is able to project an image onto a structure located at the event location. The image may correspond to the vehicle 5, the event, a passenger or preferences of the passenger, or the event location.

In an example embodiment, the exterior light effects controller 42 controls at least one of a pointing direction, color, beam shape, or beam intensity of one or more exterior lights (e.g., headlights, taillights, and/or the like) of the vehicle. For example, the headlights of the vehicle 5 may be changed to a favorite color of a passenger or to a color that corresponds to the event (e.g., red for a red-carpet event, red and green for a Christmas festival, and/or the like) and/or pointed along a path to be walked by the passenger(s) upon exiting the vehicle 5 or pointed to emphasize an architectural feature of the event location.

In an example embodiment, a vehicle shape controller 41 controls the positioning of one or more adaptable elements of the vehicle to control an exterior shape of the vehicle. For example, the vehicle 5 may include one or more adaptable elements that are movable between particular positions such that the shape of the vehicle may be controlled. For example, performing the at least one event action may include controlling the positioning of the one or more adaptable elements via the vehicle shape controller 41 to cause the vehicle 5 to have a selected exterior shape.

In an example embodiment, the interior light effects controller 44 controls at least one of a pointing direction, color, beam shape, beam intensity, projection location, or projection pattern of one or more interior lights of the vehicle 5. For example, the interior lighting of the vehicle 5 may be controlled to provide a particular lighting experience, mood, and/or the like.

In some embodiments, an interior sound controller 46 of the vehicle apparatus 30 controls one or more interior speakers of the vehicle 5 such that the soundscape (e.g., volume of sound, placement of sound within the vehicle 5, what is being played by the speakers, etc.) is controlled. For example, a song or sound clip or a particular portion of a song or sound clip selected by a passenger or by the system apparatus 10, user apparatus 20, or vehicle apparatus 30 may be played within the vehicle 5 as the vehicle 5 approaches the event location (e.g., responsive to the vehicle apparatus 30 determining that the vehicle location satisfies the proximity criteria corresponding to the event location).

In some embodiments, an exterior sound controller 48 of the vehicle apparatus 30 controls one or more exterior speakers of the vehicle 5 such that the soundscape (e.g., volume of sound, placement/projection of sound around the vehicle 5, what is being played by the speakers, etc.) is controlled. For example, a song or sound clip or a particular portion of a song or sound clip selected by a passenger or by the system apparatus 10, user apparatus 20, or vehicle apparatus 30 may be played outside the vehicle 5 as the vehicle 5 approaches the event location, as the passengers exit the vehicle, and/or the like (e.g., responsive to determining that the vehicle location satisfies the proximity criteria corresponding to the event location).

In some embodiments, the vehicle shape controller 41 controls an exterior shape of the vehicle 5, exterior light effects controller 42 controls operation of one or more exterior lights or displays 70, and/or exterior sound controller 48 controls an exterior soundscape in the vicinity of the vehicle 5 in coordination with at least one other vehicle at the event location. For example, the event location may be a location where the vehicle 5 joins up with and/or merges into a group or arrangement of vehicles that are platooning with one another. The at least one event action may include coordinating an exterior appearance (e.g., shape via the vehicle shape controller 41, exterior color, color pattern, or animated color pattern via the exterior light effects controller 42, and/or the like) of the platooning vehicles. For example, the exterior appearance of the platooning vehicles may be coordinated such that on-lookers and/or other drivers may be aware of the coordination of platooning vehicles. In some embodiments, the movement and/or handling of the platooning vehicles may be coordinated. For example, the at least one event action may include controlling movement of the vehicle, in certain embodiments.

In some embodiments, the vehicle shape controller 41 controls an exterior shape of the vehicle 5, exterior light effects controller 42 controls operation of one or more exterior lights or displays 70, and/or exterior sound controller 48 controls an exterior soundscape in the vicinity of the vehicle 5 to indicate that vehicle 5 is leaving or departing a group of platooning vehicles at the event location. For example, the event location may be a location where the vehicle 5 leaves or departs a group or arrangement of vehicles that are platooning with one another. The at least one event action may include controlling an exterior appearance (e.g., shape via the vehicle shape controller 41, exterior color, color pattern, or animated color pattern via the exterior light effects controller 42, and/or the like) of the vehicle 5 to indicate that the vehicle 5 is no longer part of the platooning vehicles.

In some embodiments, the vehicle apparatus 30 controls operation of one or more drones in proximity to the event location (e.g., via communication interface 36). In an example embodiment, the drones are onboard the vehicle 5 for at least a portion of the time the vehicle 5 is traveling along the route. The drones may be launched from the vehicle 5, for example, and controlled to provide a light display, affect an exterior soundscape at the event location, to project one or more images on structures at the event location, and/or the like.

In some embodiments, the vehicle apparatus 30 controls operation of one or more public screens 80 and/or LED displays at the event location (e.g., communication interface 36) to cause the one or more public screens 80 and/or LED displays to display one or more images or textual messages on one or more public screens 80 or LED displays located at the event location. For example, a public screen 80 or LED display may be located at the destination location or along a route to the destination location. When the vehicle location satisfies the proximity criteria corresponding to the event location (e.g., the destination location and/or the location of the public screen 80 or LED display), the vehicle apparatus 30 may communicate with the public screen 80 or LED display (e.g., via communication interface 36) responsive to the vehicle location satisfying the proximity criteria corresponding to the event location to cause the public screen 80 or LED display to display an image or textual message for a period of time. In an example embodiment, the period of time is in a range of ten seconds to ten minutes. For example, the image or textual message may be displayed such that the passengers of the vehicle 5 are able to view the image or textual message.

IV. Example Apparatus

The system apparatus 10, user apparatus 20 and/or vehicle apparatus 30 of an example embodiment may be embodied by or associated with a variety of computing devices including, for example, such as a navigation system including an in-vehicle navigation system, a vehicle control system, a personal navigation device (PND) or a portable navigation device, an advanced driver assistance system (ADAS), a global positioning system (GPS), a cellular telephone, a mobile phone, a smart phone, a personal digital assistant (PDA), a tablet, a watch, a camera, a computer, and/or other device that can perform navigation-related functions, such as digital routing and map display. Additionally or alternatively, the system apparatus 10 may be embodied in other types of computing devices, such as a server, a personal computer, a computer workstation, a laptop computer, a plurality of networked computing devices or the like, that are configured to determine at least one event action based at least in part on map data corresponding to an event location and cause components of a vehicle to perform the at least one event action when a vehicle location of the vehicle satisfies a proximity criteria corresponding to the event location.

In this regard, FIG. 2A depicts an example system apparatus 10, FIG. 2B depicts an example user apparatus 20, and FIG. 2C depicts an example vehicle apparatus 30 of an example embodiment that may be embodied by various computing devices including those identified above. As shown, the system apparatus 10 of an example embodiment may include, may be associated with or may otherwise be in communication with a processor 12 and a memory device 14 and optionally a communication interface 16 and/or a user interface 18. Similarly, a user apparatus 20 of an example embodiment may include, may be associated with, or may otherwise be in communication with a processor 22, and a memory device 24, and optionally a communication interface 26, a user interface 28, and/or optionally one or more sensors (e.g., a location sensor such as a GPS sensor; camera(s); accelerometer(s), gyroscope(s), and/or other sensors).

A vehicle apparatus 30 of an example embodiment may include, may be associated with, or may otherwise be in communication with a processor 32, and a memory device 34, and optionally a communication interface 36, a user interface 38, and/or one or more sensors 50 (e.g., a location sensor such as a GPS sensor; camera(s); 2D and/or 3D LiDAR(s); long, medium, and/or short range RADAR; ultrasonic sensors; electromagnetic sensors; (near-)IR cameras, 3D cameras, 360° cameras, accelerometer(s), gyroscope(s), and/or other sensors that enable the vehicle apparatus to determine one or more features of the corresponding vehicle's surroundings), and one or more effects controllers 40 configured to control respective components of the vehicle to cause the respective components to perform one or more event actions. For example, the effects controllers 40 may include a vehicle shape controller 41 configured to control positioning of one or more adaptable elements of the vehicle. For example, the one or more adaptable elements may be movable between particular positions such that the shape of the vehicle may be controlled. In certain embodiments, the effects controllers 40 include an exterior light effects controller 42 configured to control operation of one or more exterior lights and/or displays of the vehicle to control one or more images displayed on one or more exterior displays of the vehicle, an exterior color or color pattern of the vehicle, project an image on a structure located at the event location, control at least one of a pointing direction, color, beam shape, or beam intensity of one or more exterior lights of the vehicle, and/or the like. In some embodiments, the effects controllers 40 include an interior light effects controller 44 configured to control operation of one or more interior lights and/or displays of the vehicle to control at least of a pointing direction, color, beam shape, beam intensity, projection location, or projection pattern of one or more interior lights of the vehicle and/or at least one image displayed by an interior display of the vehicle. In various embodiments, the effects controllers 40 include an interior sound controller 46 configured to control, at least in part, an interior sound scape of the vehicle (e.g., via controlling operation of one or more interior speakers of the vehicle). In various embodiments, the effects controllers 40 include an exterior sound controller 48 configured to control, at least in part, an exterior sound scape of the vehicle (e.g., via controlling operation of one or more exterior speakers of the vehicle). In various embodiments, the effects controllers 40 may include additional and/or different effects controllers configured to control various components of the vehicle to cause performance of at least one event action.

In some embodiments, the processor 12, 22, 32 (and/or co-processors or any other processing circuitry assisting or otherwise associated with the processor) may be in communication with the memory device 14, 24, 34 via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As described above, the system apparatus 10, user apparatus 20, and/or vehicle apparatus 30 may be embodied by a computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 12, 22, 32 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 12, 22, 32 may be configured to execute instructions stored in the memory device 14, 24, 34 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the system apparatus 10, user apparatus 20, and/or vehicle apparatus 30 may include a user interface 18, 28, 38 that may, in turn, be in communication with the processor 12, 22, 32 to provide output to the user, such as a proposed route, and, in some embodiments, to receive an indication of a user input, such as user preference, a destination location, and/or the like. As such, the user interface may include a display and, in some embodiments, may also include a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor (e.g., memory device 14, 24, 34 and/or the like).

The system apparatus 10, user apparatus 20, and/or vehicle apparatus 30 may optionally include a communication interface 16, 26, 36. The communication interface may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In addition to embodying the system apparatus 10, user apparatus 20, and/or vehicle apparatus 30 of an example embodiment, a navigation system may also include or have access to a geographic database that includes a variety of data (e.g., map information/data) utilized in constructing a route or navigation path and determining the time to traverse the route or navigation path. For example, a geographic database may include node data records (e.g., including anchor node data records comprising junction identifiers), road segment or link data records, point of interest (POI) data records and other data records. More, fewer, or different data records can be provided. In one embodiment, the other data records include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example. In example embodiments, the data records (e.g., node data records, link data records, POI data records, and/or other data records) may comprise computer-executable instructions, a reference to an function repository that comprises computer-executable instructions, one or more coefficients and/or parameters to be used in accordance with an algorithm for performing the analysis, one or more response criteria for providing a response indicating a result of the analysis, and/or the like. In example embodiments, the vehicle apparatus 30 may be configured to execute computer-executable instructions provided and/or referred to by a communication provided by a system apparatus 10 and/or a user apparatus 20. In example embodiments, the system apparatus 10 may be configured to modify, update, and/or the like one or more data records of the geographic database.

In an example embodiment, the road segment data records are links or segments, e.g., maneuvers of a maneuver graph, representing roads, lanes of roads, streets, or paths, as can be used in the calculated route or recorded route information for determination of one or more personalized routes (e.g., from a current or other origin location to a destination location such as an event location or the like). The node data records are end points corresponding to the respective links or segments of the road segment data records. The road link data records and the node data records represent a road network, such as used by vehicles, cars, and/or other entities. Alternatively, the geographic database can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database can include data about the POIs and their respective locations in the POI data records. The geographic database can also include data about places, such as cities, towns, or other communities, and other geographic features, such as bodies of water, mountain ranges, etc. Such place or feature data can be part of the POI data or can be associated with POIs or POI data records (such as a data point used for displaying or representing a position of a city). In addition, the geographic database can include and/or be associated with event data (e.g., traffic incidents, constructions, scheduled events, unscheduled events, etc.) associated with the POI data records or other records of the geographic database.

The geographic database can be maintained by the content provider (e.g., a map developer) in association with the services platform. By way of example, the map developer can collect geographic data to generate and enhance the geographic database. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used. In example embodiments, the geographic database may be updated based on information/data provided by one or more vehicle apparatuses.

The geographic database can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions. The navigation-related functions can correspond to vehicle navigation or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases. Regardless of the manner in which the databases are compiled and maintained, a navigation system that embodies an apparatus 10, 20, 30 in accordance with an example embodiment may determine the time to traverse a route that includes one or more turns at respective intersections more accurately.

### V. Apparatus, Methods, and Computer Program Products

As described above, FIGS. 3 and 4 illustrate flowcharts of apparatuses 10, 20, 30, method, and computer program product according to example embodiments of the present disclosure. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 14, 24, 34 of an apparatus employing an embodiment of the present invention and executed by the processor 12, 22, 32 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

### VI. Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
obtaining, by at least one processor, map information corresponding to an event location;
based at least in part on the map information corresponding to the event location, determining, by the at least one processor, at least one event action to be performed by a vehicle responsive to a vehicle location indicating a location of the vehicle satisfying a proximity criteria corresponding to the event location; and
causing, by the at least one processor, one or more components of the vehicle to perform the at least one event action responsive to determining that the vehicle location satisfies the proximity criteria corresponding to the event location.

2. The method of claim 1, wherein the map information corresponding to the event location comprises one or more of information regarding one or more road segments located at least one of proximate the event location or along a route to be traveled by the vehicle enroute to the event location, one or more points of interest proximate the event location or along the route, at least a portion of the route to be traveled by the vehicle enroute to the event location, an estimated time of arrival of the vehicle at the event location, traffic information for at least one of road segments proximate the event location or along the route to be traveled by the vehicle enroute to the event location, weather information for at least one of the event location or along the route to be traveled by the vehicle enroute to the event location, a 3D model of the event location, traffic light information for one or more traffic lights along the route to be traveled by the vehicle enroute to the event location, or information regarding an event occurring at the event location.

3. The method of claim 1, wherein the event location is a destination of a route being traversed by the vehicle, a location along the route being traversed by the vehicle at which the vehicle will platoon with at least one other vehicle, a location of interest along the route being traversed by the vehicle, a location along the route being traversed by the vehicle that is a destination of another vehicle.

4. The method of claim 1, wherein the at least one event action is determined based at least in part on one or more of an identity of a passenger of the vehicle, a number of passengers of the vehicle, user preferences associated with at least one passenger of the vehicle, user input provided by one or more passengers of the vehicle, a physical characteristic or appearance of at least one passenger of the vehicle, sensor data generated by one or more sensors of the vehicle, or information regarding capabilities of the vehicle.

5. The method of claim 1, wherein the at least one event action comprises at least one of controlling an exterior color or color pattern of the vehicle; controlling an exterior shape of the vehicle; projecting an image on a structure located at the event location; or controlling at least one of a pointing direction, color, beam shape, or beam intensity of one or more exterior lights of the vehicle.

6. The method of claim 1, wherein the at least one event action comprises controlling at least one of a pointing direction, color, beam shape, beam intensity, projection location, or projection pattern of one or more interior lights of the vehicle.

7. The method of claim 1, wherein the at least one event action comprises controlling a sound scape at least one of interior to the vehicle or exterior to the vehicle.

8. The method of claim 1, wherein the at least one event action is a coordinated action performed in coordination by two or more vehicles at the event location.

9. The method of claim 1, wherein the at least one event action comprises at least one of controlling operation of one or more drones in proximity to the event location, movement of the vehicle, or causing display of one or more images or textual messages on one or more public screens at the event location.

10. The method of claim 1, wherein the proximity criteria corresponding to the event location is satisfied when at least one of the vehicle is expected to arrive at the event location within a set amount of time, the vehicle is within a set distance of the event location, or a door of the vehicle is opened within the set distance of the event location.

11. An apparatus comprising at least one processor and at least one memory storing computer program code, the at least one memory and the computer program code is configured to, with the at least one processor, cause the apparatus to at least:
obtain map information corresponding to an event location;
based at least in part on the map information corresponding to the event location, determine at least one event action to be performed by a vehicle responsive to a vehicle location indicating a location of the vehicle satisfying a proximity criteria corresponding to the event location; and
cause one or more components of the vehicle to perform the at least one event action responsive to determining that the vehicle location satisfies the proximity criteria corresponding to the event location.

12. The apparatus of claim 11, wherein the vehicle comprises at least one of one or more LED lights or one or more LED displays on one or more exterior surfaces of the vehicle and the at least one event action includes controlling operation of the at least one of one or more LED lights or one or more LED displays on the one or more exterior surfaces of the vehicle to control an appearance of the vehicle.

13. The apparatus of claim 11, wherein the event location is a destination of a route being traversed by the vehicle, a location along the route being traversed by the vehicle at which the vehicle will platoon with at least one other vehicle, a location of interest along the route being traversed by the vehicle, a location along the route being traversed by the vehicle that is a destination of another vehicle.

14. The apparatus of claim 11, wherein the proximity criteria corresponding to the event location is satisfied when at least one of the vehicle is expected to arrive at the event location within a set amount of time, the vehicle is within a set distance of the event location, or a door of the vehicle is opened within the set distance of the event location.

15. The apparatus of claim 11, wherein the at least one event action comprises at least one of:
controlling an exterior color or color pattern of the vehicle,
controlling an exterior shape of the vehicle,
projecting an image on a structure located at the event location,
controlling at least one of a pointing direction, color, beam shape, or beam intensity of one or more exterior lights of the vehicle,
controlling at least of a pointing direction, color, beam shape, beam intensity, projection location, or projection pattern of one or more interior lights of the vehicle,
controlling a sound scape at least one of interior to the vehicle or exterior to the vehicle,
performing a coordinated action in coordination with at least one additional vehicle at the event location,
controlling operation of one or more drones in proximity to the event location, or
controlling movement of the vehicle, or causing display of one or more images or textual messages on one or more public screens at the event location.

16. A computer program product comprising at least one non-transitory computer-readable storage medium having computer-readable program code portions stored therein, the computer-readable program code portions comprising executable portions configured, when executed by a processor of an apparatus, to cause the apparatus to:
obtain map information corresponding to an event location;
based at least in part on the map information corresponding to the event location, determine at least one event action to be performed by a vehicle responsive to a vehicle location indicating a location of the vehicle satisfying a proximity criteria corresponding to the event location; and
cause one or more components of the vehicle to perform the at least one event action responsive to determining that the vehicle location satisfies the proximity criteria corresponding to the event location.

17. The computer program product of claim 16, wherein the at least one event action is determined based at least in part on one or more of an identity of a passenger of the vehicle, a number of passengers of the vehicle, user preferences associated with at least one passenger of the vehicle, user input provided by one or more passengers of the vehicle, a physical characteristic or appearance of at least one passenger of the vehicle, sensor data generated by one or more sensors of the vehicle, or information regarding capabilities of the vehicle.

18. The computer program product of claim 16, wherein the event location is a destination of a route being traversed by the vehicle, a location along the route being traversed by the vehicle at which the vehicle will platoon with at least one other vehicle, a location of interest along the route being traversed by the vehicle, a location along the route being traversed by the vehicle that is a destination of another vehicle.

19. The computer program product of claim 16, wherein the proximity criteria corresponding to the event location is satisfied when at least one of the vehicle is expected to arrive at the event location within a set amount of time, the vehicle is within a set distance of the event location, or a door of the vehicle is opened within the set distance of the event location.

20. The computer program product of claim 16, wherein the at least one event action comprises at least one of:
controlling an exterior color or color pattern of the vehicle,
controlling an exterior shape of the vehicle,
projecting an image on a structure located at the event location,
controlling at least one of a pointing direction, color, beam shape, or beam intensity of one or more exterior lights of the vehicle,
controlling at least of a pointing direction, color, beam shape, beam intensity, projection location, or projection pattern of one or more interior lights of the vehicle,
controlling a sound scape at least one of interior to the vehicle or exterior to the vehicle,
performing a coordinated action in coordination with at least one additional vehicle at the event location,
controlling operation of one or more drones in proximity to the event location, or
controlling movement of the vehicle, or causing display of one or more images or textual messages on one or more public screens at the event location.
